(19) United States
(12) Patent Application Publication
(10) Pub. No.: US 2019/0124170 A1
(43) Pub. Date: Apr. 25, 2019

(54) SYSTEMS AND METHODS FOR RETAINING MEANINGFUL CONNECTIONS

(71) Applicant: Facebook, Inc., Menlo Park, CA (US)

(72) Inventors: Li Ju, Issaquah, WA (US); Ramanathan Palaniappan, Issaquah, WA (US); Matthew Bryan Folz, San Francisco, CA (US); Baijie Lu, Seattle, CA (US); Kevin Donald Kelly, Bainbridge Island, WA (US)

(21) Appl. No.: 15/788,765

(22) Filed: Oct. 19, 2017

(51) Int. Cl. H04L 29/08

(52) U.S. Cl. CPC H04L 67/22; H04L 51/32

(57) ABSTRACT

The disclosed computer-implemented method may include measuring a user's activity for at least a current time period with respect to a social networking group of a social network. The method may include determining, based on at least the user's activity, whether the user will establish a meaningful connection with the social networking group for a next time period. The meaningful connection may indicate that the user satisfies a threshold amount of activity with the social networking group for a time period. The method may include selecting, based on the determination, content associated with the social networking group. The method may include providing the selected content for display to the user. Various other methods, systems, and computer-readable media are also disclosed.

### BACKGROUND

Social networks allow users to connect and share various forms of content, such as webpages, articles, user posts, comments, etc. As users continue to interact on a social network, more content is generated for users to consume and interact with. A user's experience may be improved when new content is available on the social network, rather than the user repeatedly being exposed to a stagnant set of content. Thus, increasing user activity may improve a user's experience on the social network.

The social network may provide users the ability to form groups which may be centered around common interests, relationships, etc. When a user spends at least a certain amount of time on the social group, such as 30 minutes in a given week, the user may establish a meaningful connection with the social networking group for that week. When the social networking group has meaningful connections with numerous users, the social networking group may be more likely to provide fresh content to its users. However, over time a user may break the meaningful connection due to lack of activity. For example, a user who has a meaningful connection with a social networking group one week may not maintain the meaningful connection the following week. To improve users' overall experience in a social network, and particularly within a social networking group, it may be advantageous to prevent the loss of meaningful connections.

### SUMMARY

As will be described in greater detail below, the instant disclosure describes various systems and methods for retaining meaningful connections by predicting when a user will not retain a meaningful connection with a social networking group.

In one example, a method for retaining meaningful connections may include measuring a user's activity for at least a current time period with respect to a social networking group of a social network. The method may include determining, based on at least the user's activity, whether the user will establish a meaningful connection with the social networking group for a next time period. The meaningful connection may indicate the user satisfies a threshold amount of activity with the social networking group for a time period. The method may include selecting, based on the determination, content associated with the social networking group. The method may include providing the selected content for display to the user.

In some examples, the determining step of the method may be further based on whether the user was active in the social networking group for the current time period, whether the user was active in the social networking group for a prior time period, and a number of times the user was active in the social networking group during one or more prior time periods. The determining step of the method may be further based on an amount of time the user was active in the social networking group for the current time period. The determining step of the method may be further based on a number of meaningful connections the user established during one or more prior time periods. The determining step of the method may be further based on a time elapsed since the user joined the social network. The determining step of the method may be further based on a number of meaningful connections associated with the social networking group for the current time period. The selecting step of the method may further comprise selecting content associated with the social networking group when the determination indicates that the user will not establish the meaningful connection for the next time period. The selecting step of the method may further comprise selecting content from the social network to provide to the user.

In addition, a corresponding system for retaining meaningful connections may include one or more processors and a memory comprising instructions. The instructions, when executed by the one or more processors, may cause the system to measure a user's activity for at least a current time period with respect to a social networking group of a social network. The instructions may cause the system to determine, based on at least the user's activity, whether the user will establish a meaningful connection with the social networking group for a next time period. The meaningful connection may indicate the user satisfies a threshold amount of activity with the social networking group for a time period. The instructions may cause the system to select, based on the determination, content associated with the social networking group. The instructions may cause the system to provide the selected content for display to the user.

In some examples, the determining may be further based on an amount of time the user was active in the social networking group for the current time period. The determining may be further based on a number of meaningful connections the user established during one or more prior time periods. The determining may be further based on a time elapsed since the user joined the social network. The determining may be further based on a number of meaningful connections associated with the social networking group for the current time period. The selecting may further comprise selecting content associated with the social networking group when the determination indicates that the user will not establish the meaningful connection for the next time period.

In some examples, the above-described method may be encoded as computer-readable instructions on a computer-readable medium. For example, a computer-readable medium may include one or more computer-executable instructions that, when executed by at least one processor of a computing device, may cause the computing device to measure a user's activity for at least a current time period with respect to a social networking group of a social network. The instructions may cause the computing device to determine, based on at least the user's activity, whether the user will establish a meaningful connection with the social networking group for a next time period. The meaningful connection may indicate the user satisfies a threshold amount of activity with the social networking group for a time period. The instructions may cause the computing device to select, based on the determination, content associated with the social networking group. The instructions may cause the computing device to provide the selected content for display to the user.

In some examples, the instructions for determining may be further based on an amount of time the user was active in the social networking group for the current time period. The instructions for determining may be further based on a number of meaningful connections the user established during one or more prior time periods. The instructions for determining may be further based on a time elapsed since the user joined the social network. The instructions for determining may be further based on a number of meaningful connections associated with the social networking group for the current time period. The instructions for selecting may further comprise selecting content associated with the social networking group when the determination indicates that the user will not establish the meaningful connection for the next time period.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for retaining meaningful connections.

FIG. 2 is a flow diagram of an exemplary method for retaining meaningful connections.

FIG. 3 is a sample screen showing content selected by an exemplary system for retaining meaningful connections.

FIG. 4 is a sample screen of notifications from an exemplary system for retaining meaningful connections.

FIG. 5 is a block diagram of an example computing system capable of implementing one or more of the embodiments described and/or illustrated herein.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to systems and methods for retaining meaningful connections. As will be explained in greater detail below, embodiments of the instant disclosure may measure a user's activity with respect to a social networking group and determine whether the user will establish a meaningful connection with the social networking group. Based on this determination, content associated with the social networking group may be selected and provided for display to the user. By predicting whether the user will retain the meaningful connection from week to week, the user may be provided content from the social networking group as needed, for example, as posts in the user's news feed or as notifications to the user. This may improve the functioning of a computer system by reducing processing, communications, and associated resources and overhead. Rather than processing and sending content to all users of a social networking group, the content may be selectively provided to users predicted to not retain meaningful connections. Thus, computing resources may be more efficiently utilized. In addition, the present disclosure provides a technical solution to a technical problem of utilizing server computing resources more efficiently.

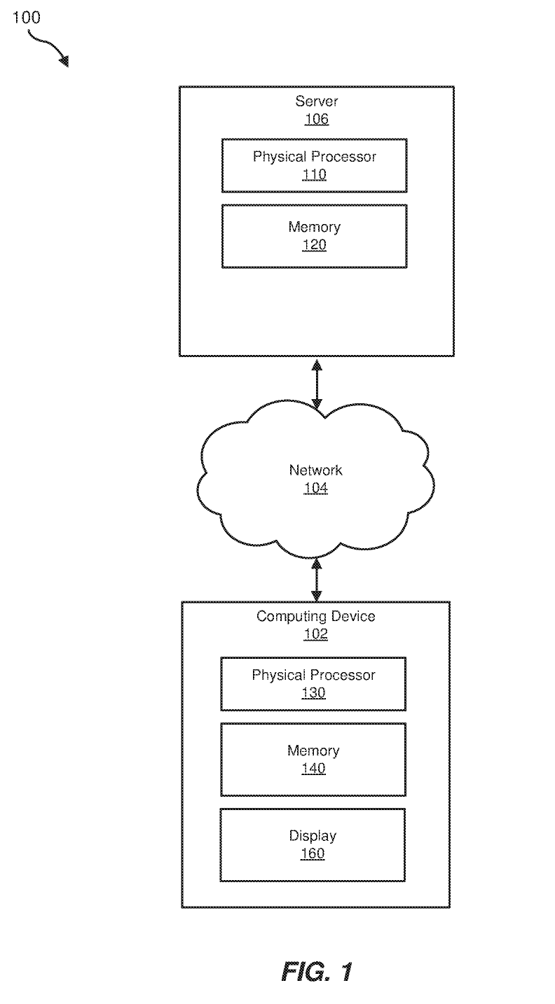

The following will provide, with reference to FIGS. 1-5, detailed descriptions of of an exemplary network environment, a flowchart of a process according to aspects of the present disclosure, sample screens of aspects of the present disclosure, and an exemplary computing system.

FIG. 1 illustrates an exemplary network environment 100 implementing aspects of the present disclosure. The network environment 100 includes a computing device 102, a network 104, and a server 106. The computing device 102 may be a client device or user device, such a desktop computer, laptop computer, tablet device, smartphone, or other computing device. The computing device 102 includes a physical processor 130, which may be one or more processors, and a memory 140, which may store instructions such as applications. The computing device 102 includes a display 160, which may be any type of display device, such as an LED, LCD, etc.

The server 106 may be one or more servers which host a social network. The server 106 includes a physical processor 110, which may be one or more processors, and a memory 120, which may store instructions as described herein. A social network may be a service accessible to users through computing devices that are connected through a network, such as the internet. Users may establish connections to other users, and the social network may provide a platform for users to interact and communicate with connected users. For example, users may share content, including web pages or links, user generated content such as photos, videos, posts, and comment or message each other through the social network.

The computing device 102 is communicatively coupled to the server 106 through the network 104. The network 104 may be any communication network, such as the internet, and may comprise one or more physical connections, such as LAN, and/or wireless connections, such as WAN.

A user may use the computing device 102 to access a social network hosted on the server 106. The user may be part of a social networking group on the social network. A social networking group may be a group of users on the social network who may be connected based around a common interest or other shared feature. One or more users of the social networking group may have control over membership of the social networking group. The social networking group may provide additional features and interactions amongst group members that may not be available on the social network at large. The user may view content from the social network through the display 160 of the computing device 102. The user may establish a meaningful connection with the social networking group. A meaningful connection may refer to a user being a participating member of the social networking group, rather than a cursory visitor. The meaningful connection may be established based on an amount of time the user has spent of the social networking group. For example, a meaningful connection may be established if a user spends at least 30 minutes on the social networking group in a given week, although other threshold amounts of activity for a time period may be used. A user may spend time on a social networking group by consuming content provided by way of the social networking group, for instance by viewing posts posted to the social networking group, responding to posts on the social networking group, or by posting content to the social networking group, such as providing posts, user generated content, or web content to the social networking group, etc. The time spent on the social networking group may be measured by an amount of time the user has been consuming or providing content with respect to the social networking group.

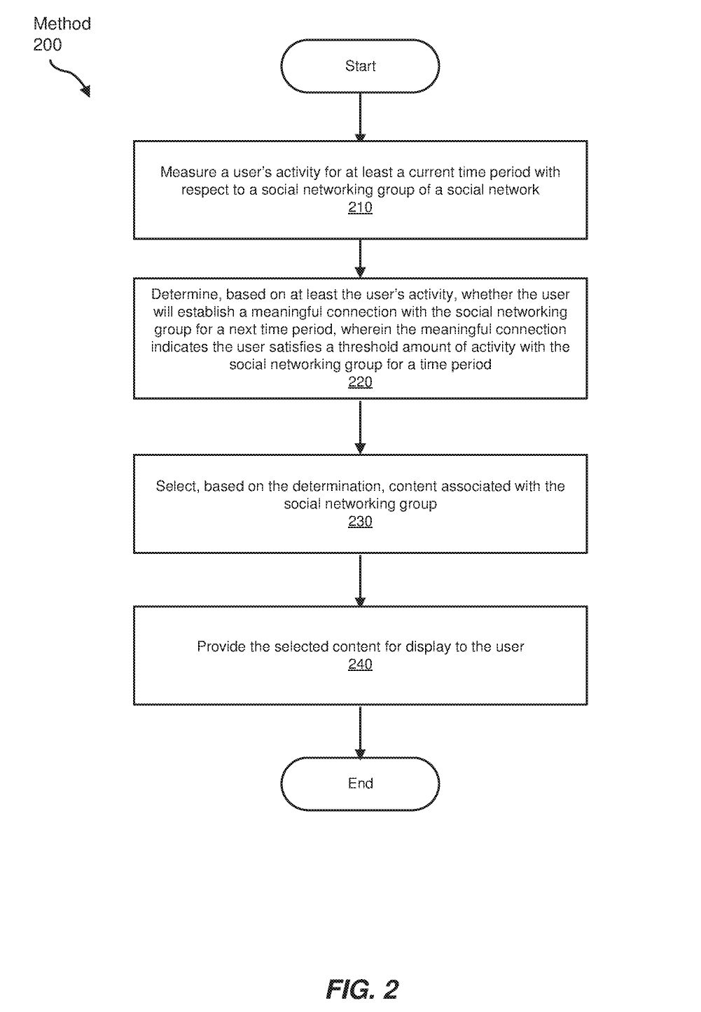

FIG. 2 shows a flowchart of a process 200 according to aspects of the present disclosure. The user may access the social network hosted on, for example, the server 106 using the computing device 102. The server 106 may perform one or more steps described below, although in other implementations additional servers and/or the computing device 102 may perform one or more steps. In addition, the steps described below may follow a different order and steps may be repeated.

At block 210, the server 106 may measure the user's activity for at least a current time period with respect to a social networking group of a social network. For example, if the server 106 uses one week as the time period, the server 106 may measure how much time the user has spent in the social networking group for the current week.

The server 106 may measure other features associated with the user and/or the social networking group, which may be included with the measured user's activity. The server 106 may measure user-related features, such as how much time the user has spent on the social network (e.g., the user's age in the social network), and how much time the user has spent overall in social networking groups.

The server 106 may measure group-related features, such as how many meaningful connections the social networking group had the previous week, how many different users have used the social networking group, how many total meaningful connections the social networking group had in the first day of the week, and how many total meaningful connections the social networking group had in the last day of the week.

The server 106 may measure group usage-related features, such as how much time the user has spent in the social networking group, whether the user had a meaningful connection with the social networking group the previous week, how many weeks the user established a meaningful connection in the previous month, how many connected days for the current meaningful connection, and how much time the user has spent in the each day (e.g., first day, . . . seventh day) of the week for the meaningful connection.

At block 220, the server 106 may determine, based on at least the user's activity, whether the user will establish a meaningful connection with the social networking group for a next time period. As noted above, the meaningful connection may indicate the user satisfies a threshold amount of activity with the social networking group for a time period. For example, the threshold amount of activity may be 30 minutes in a week, although in other implementations other thresholds may be used. The server 106 may use one or more features, as described with respect to block 210, to predict whether the user will establish the meaningful connection for the next time period. The prediction may be a binary determination, such as yes or no, or may be a probability.

According to some implementations, whether the user will establish the meaningful connection for the next time period may be based on a regression analysis. For example, the server 106 may examine whether the user was active in (e.g. has spent any amount of time in) the social networking group for the current time period, whether the user was active in the social networking group for a prior time period, and a number of times the user was active in the social networking group during one or more prior time periods. A larger amount of measured activity may indicate the user will likely establish the meaningful connection for the next time period. A smaller amount of measured activity may indicate the user will not likely establish the meaningful connection for the next time period.

According to some other implementations, whether the user will establish the meaningful connection for the next time period may be based on various weighted factors, based on the features described above. For example, the server 106 may determine a probability the user will establish the meaningful connection based on one or more of an amount of time the user was active in the social networking group for the current time period, a number of meaningful connections the user established during one or more prior time periods, a time elapsed since the user joined the social network, or a number of meaningful connections associated with the social networking group for the current time period.

At block 230, the server 106 selects, based on the determination at block 220, content associated with the social networking group. The server 106 may select content associated with the social networking group when the determination indicates that the user will not establish the meaningful connection for the next time period. For example, if the user is not likely to establish the meaningful connection next week, the server 106 may provide content associated with the social networking group to remind the user about the social networking group and to encourage the user to spend time on the social networking group. In other words, the server 106 may select additional content associated with the social networking group than it would have otherwise selected. If the user is likely to establish the meaningful connection next week, the user may not need additional encouragement, and no additional content associated with the social networking group may be selected. In other words, the server 106 may not modify how much content associated with the social networking group is selected. Alternatively, the server 106 may select less or no content associated with the social networking group.

In implementations where the server 106 calculates the probability that a particular user will remain active in a group and retain a meaningful connection, the server 106 may select an amount and priority of content associated with the social networking group based on the probability. The server 106 may select less content for a higher probability of maintaining the meaningful connection, and more content for a lower probability.

The server 106 may select content from the social network to provide to the user. For example, the server 106 may select content to populate the user's news feed and provide notifications relevant to the user. If the server 106 selects content associated with the social networking group, the content associated with the social networking group may replace or take priority over content from the social network. In certain implementations, the content associated with the social networking group may be the first content to populate the user's news feed and/or notifications.

A feed may be a stream of content from the social network that is provided to the user. The news feed may be populated based on a user's connections and/or a user's interests as provided to the social network by the user. The news feed may be a default feed for the user, and may be the first feed presented to the user when the user visits the social network. Notifications may be alerts provided to the user separately from feeds. Notifications may include, for instances, new post updates, event reminders, message alerts, etc.

The selected content associated with the social networking group may be prioritized into the news feed (or any other type of feed), such as stories missed or promotional units, or as notifications, such as group activity notifications. For example, a higher probability of establishing the meaningful connection may lower he priority of the selected content to one of the feeds, rather than the notifications. The different feeds may have different levels of priority, such as news feed having the highest priority. A lower probability of establishing the meaningful connection may increase priority of the selected content to the notifications, rather than one of the feeds. A number and/or frequency of selected content may also increase as the probability is lower and may decrease as the probability is higher.

At block 240, the server 106 provides the selected content for display to the user. The selected content may be provided as posts in one of the user's feeds, as notifications to the user, or via any other suitable communication channel.

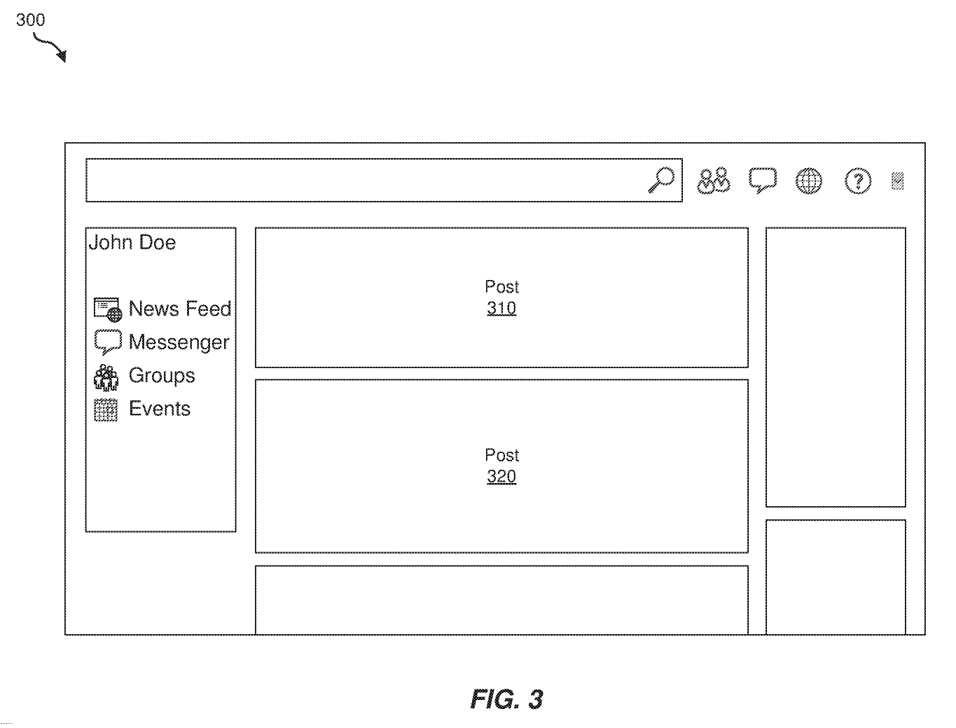

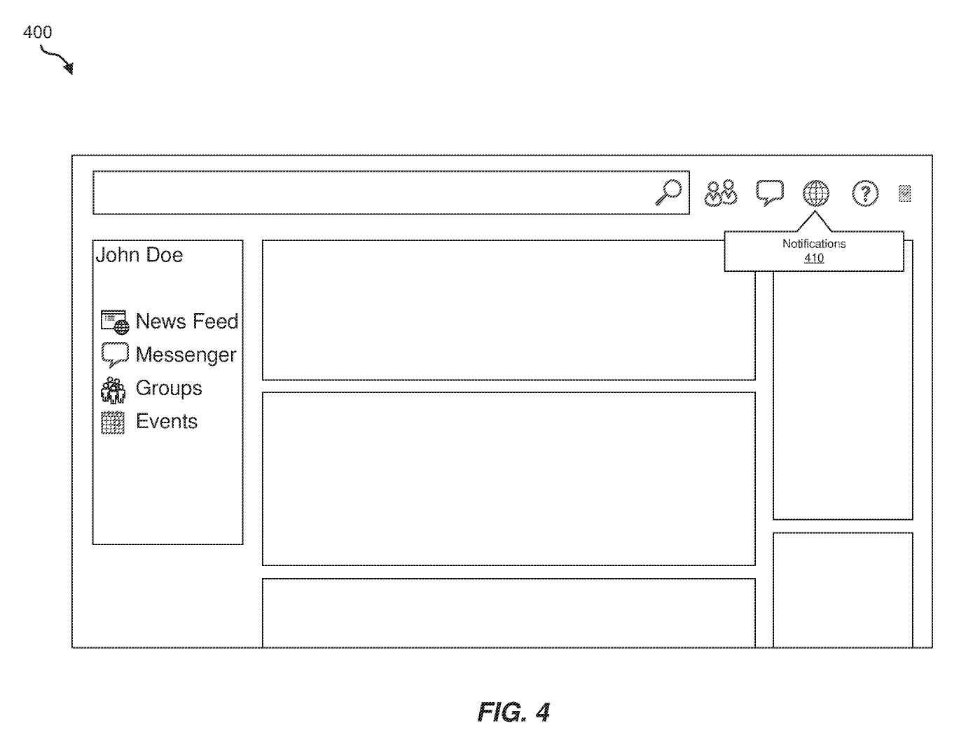

FIGS. 3 and 4 depict example screens of how the selected content may be displayed to the user, such as on the display 160 of the computing device 102. FIG. 3 shows a screen 300 of the selected content provided in a feed. The screen 300 shows the user's news feed page, which includes a post 310 and a post 320.

When the user views the news feed page, the user is presented the post 310 and the post 320. The posts 310 and 320 may include content from the social network, such as shared links, comments, replies to comments, reactions to other posts, etc. However, based on whether the user will establish the meaningful connection with the social networking group next week, the posts 310 and/or 320 may be content associated with the social networking group. The other content may be pushed lower in the feed and the selected content presented first in order to encourage the user to spend time in the social networking group, if the user is not likely to establish the meaningful connection. If the user is likely to establish the meaningful connection, the posts 310 and/or 320 may not include content associated with the social networking group. For example, the posts 310 and/or 320 may be content associated with another social networking group that the user is not likely to establish a meaningful connection.

FIG. 4 shows a screen 400 of the selected content provided as notifications. The screen 400 includes notifications 410, which may be updates on social network activity provided to the user, such as new posts directed to the user, new comments or replies to the user's posts, etc. The notifications 410 may be modified by the server 106 based on whether the user will establish the meaningful connection next week. For example, if the user is likely to establish the meaningful connection, the notifications 410 may include less or no notifications related to the social networking group. A frequency of notifications related to the social networking group may be reduced. Inversely, if the user is not likely to establish the meaningful connection, the notifications 410 may include more notifications related to the social networking group. A frequency of notifications related to the social networking group may be increased. A priority or placement of the notifications in the notifications 410 may be modified, for example to place greater priority on notifications related to the social networking group when the user is not likely to establish the meaningful connection.

According to aspects of the present disclosure, a system is provided for retaining meaningful connections between users of a social network and a social networking group in the social network. The system may use various factors, such as user activity and characteristics of the social networking group, to predict whether a user will establish a meaningful connection with a social networking group. A meaningful connection indicates that the user spent a minimum amount of time, such as 30 minutes, on the social networking group for a given week. The system may predict whether the user will establish a meaningful connection the following week. If the system predicts the user will not establish or retain a meaningful connection, the system may modify content presented to the user to prod the user maintain the meaningful connection. For example, the system ay present content from the social networking group, or provide additional notifications about the social networking group. Thus, the system may be able to more efficiently utilize computing resources by better focusing the provision of content to certain users, rather than all users.

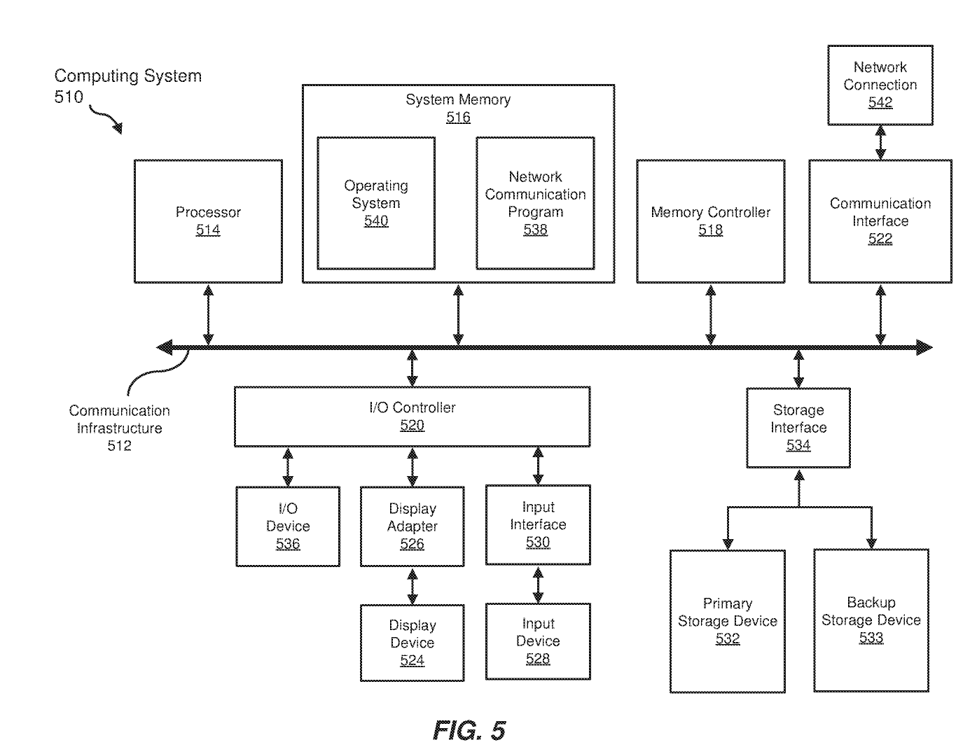

FIG. 5 is a block diagram of an example computing system 510 capable of implementing one or more of the embodiments described and/or illustrated herein. For example, all or a portion of computing system 510 may perform and/or be a means for performing, either alone or in combination with other elements, one or more of the steps described herein (such as one or more of the steps illustrated in FIG. 2). All or a portion of computing system 510 may also perform and/or be a means for performing any other steps, methods, or processes described and/or illustrated herein.

Computing system 510 broadly represents any single or multi-processor computing device or system capable of executing computer-readable instructions. Examples of computing system 510 include, without limitation, workstations, laptops, client-side terminals, servers, distributed computing systems, handheld devices, or any other computing system or device. In its most basic configuration, computing system 510 may include at least one processor 514 and a system memory 516.

Processor 514 generally represents any type or form of physical processing unit (e.g., a hardware-implemented central processing unit) capable of processing data or interpreting and executing instructions. In certain embodiments, processor 514 may receive instructions from a software application or module. These instructions may cause processor 514 to perform the functions of one or more of the example embodiments described and/or illustrated herein.

System memory 516 generally represents any type or form of volatile or non-volatile storage device or medium capable of storing data and/or other computer-readable instructions. Examples of system memory 516 include, without limitation, Random Access Memory (RAM), Read Only Memory (ROM), flash memory, or any other suitable memory device. Although not required, in certain embodiments computing system 510 may include both a volatile memory unit (such as, for example, system memory 516) and a non-volatile storage device (such as, for example, primary storage device 532, as described in detail below).

In some examples, system memory 516 may store and/or load an operating system 540 for execution by processor 514. In one example, operating system 540 may include and/or represent software that manages computer hardware and software resources and/or provides common services to computer programs and/or applications on computing system 510. Examples of operating system 540 include, without limitation, LINUX, JUNOS, MICROSOFT WINDOWS, WINDOWS MOBILE, MAC OS, APPLE'S IOS, UNIX, GOOGLE CHROME OS, GOOGLE'S ANDROID, SOLARIS, variations of one or more of the same, and/or any other suitable operating system.

In certain embodiments, example computing system 510 may also include one or more components or elements in addition to processor 514 and system memory 516. For example, as illustrated in FIG. 5, computing system 510 may include a memory controller 518, an Input/Output (I/O) controller 520, and a communication interface 522, each of which may be interconnected via a communication infrastructure 512. Communication infrastructure 512 generally represents any type or form of infrastructure capable of facilitating communication between one or more components of a computing device. Examples of communication infrastructure 512 include, without limitation, a communication bus (such as an Industry Standard Architecture (ISA), Peripheral Component Interconnect (PCI), PCI Express (PCIe), or similar bus) and a network.

Memory controller 518 generally represents any type or form of device capable of handling memory or data or controlling communication between one or more components of computing system 510. For example, in certain embodiments memory controller 518 may control communication between processor 514, system memory 516, and I/O controller 520 via communication infrastructure 512.

I/O controller 520 generally represents any type or form of module capable of coordinating and/or controlling the input and output functions of a computing device. For example, in certain embodiments I/O controller 520 may control or facilitate transfer of data between one or more elements of computing system 510, such as processor 514, system memory 516, communication interface 522, display adapter 526, input interface 530, and storage interface 534.

As illustrated in FIG. 5, computing system 510 may also include at least one display device 524 coupled to I/O controller 520 via a display adapter 526. Display device 524 generally represents any type or form of device capable of visually displaying information forwarded by display adapter 526. Similarly, display adapter 526 generally represents any type or form of device configured to forward graphics, text, and other data from communication infrastructure 512 (or from a frame buffer, as known in the art) for display on display device 524.

As illustrated in FIG. 5, example computing system 510 may also include at least one input device 528 coupled to I/O controller 520 via an input interface 530. Input device 528 generally represents any type or form of input device capable of providing input, either computer or human generated, to example computing system 510. Examples of input device 528 include, without limitation, a keyboard, a pointing device, a speech recognition device, variations or combinations of one or more of the same, and/or any other input device.

Additionally or alternatively, example computing system 510 may include additional I/O devices. For example, example computing system 510 may include I/O device 536. In this example, I/O device 536 may include and/or represent a user interface that facilitates human interaction with computing system 510. Examples of I/O device 536 include, without limitation, a computer mouse, a keyboard, a monitor, a printer, a modem, a camera, a scanner, a microphone, a touchscreen device, variations or combinations of one or more of the same, and/or any other I/O device.

Communication interface 522 broadly represents any type or form of communication device or adapter capable of facilitating communication between example computing system 510 and one or more additional devices. For example, in certain embodiments communication interface 522 may facilitate communication between computing system 510 and a private or public network including additional computing systems. Examples of communication interface 522 include, without limitation, a wired network interface (such as a network interface card), a wireless network interface (such as a wireless network interface card), a modem, and any other suitable interface. In at least one embodiment, communication interface 522 may provide a direct connection to a remote server via a direct link to a network, such as the Internet. Communication interface 522 may also indirectly provide such a connection through, for example, a local area network (such as an Ethernet network), a personal area network, a telephone or cable network, a cellular telephone connection, a satellite data connection, or any other suitable connection.

In certain embodiments, communication interface 522 may also represent a host adapter configured to facilitate communication between computing system 510 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 522 may also allow computing system 510 to engage in distributed or remote computing. For example, communication interface 522 may receive instructions from a remote device or send instructions to a remote device for execution.

In some examples, system memory 516 may store and/or load a network communication program 538 for execution by processor 514. In one example, network communication program 538 may include and/or represent software that enables computing system 510 to establish a network connection 542 with another computing system (not illustrated in FIG. 5) and/or communicate with the other computing system by way of communication interface 522. In this example, network communication program 538 may direct the flow of outgoing traffic that is sent to the other computing system via network connection 542. Additionally or alternatively, network communication program 538 may direct the processing of incoming traffic that is received from the other computing system via network connection 542 in connection with processor 514.

Although not illustrated in this way in FIG. 5, network communication program 538 may alternatively be stored and/or loaded in communication interface 522. For example, network communication program 538 may include and/or represent at least a portion of software and/or firmware that is executed by a processor and/or Application Specific Integrated Circuit (ASIC) incorporated in communication interface 522.

As illustrated in FIG. 5, example computing system 510 may also include a primary storage device 532 and a backup storage device 533 coupled to communication infrastructure 512 via a storage interface 534. Storage devices 532 and 533 generally represent any type or form of storage device or medium capable of storing data and/or other computer-readable instructions. For example, storage devices 532 and 533 may be a magnetic disk drive (e.g., a so-called hard drive), a solid state drive, a floppy disk drive, a magnetic tape drive, an optical disk drive, a flash drive, or the like. Storage interface 534 generally represents any type or form of interface or device for transferring data between storage devices 532 and 533 and other components of computing system 510.

In certain embodiments, storage devices 532 and 533 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 532 and 533 may also include other similar structures or devices for allowing computer software, data, or other computer-readable instructions to be loaded into computing system 510. For example, storage devices 532 and 533 may be configured to read and write software, data, or other computer-readable information. Storage devices 532 and 533 may also be a part of computing system 510 or may be a separate device accessed through other interface systems.

Many other devices or subsystems may be connected to computing system 510. Conversely, all of the components and devices illustrated in FIG. 5 need not be present to practice the embodiments described and/or illustrated herein. The devices and subsystems referenced above may also be interconnected in different ways from that shown in FIG. 5. Computing system 510 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 510. All or a portion of the computer program stored on the computer-readable medium may then be stored in system memory 516 and/or various portions of storage devices 532 and 533. When executed by processor 514, a computer program loaded into computing system 510 may cause processor 514 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 510 may be configured as an Application Specific Integrated Circuit (ASIC) adapted to implement one or more of the example embodiments disclosed herein.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

The term “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
measuring a user's activity for at least a current time period with respect to a social networking group of a social network;
determining, based on at least the user's activity, whether the user will establish a meaningful connection with the social networking group for a next time period, wherein the meaningful connection indicates the user satisfies a threshold amount of activity with the social networking group for a time period;
selecting, based on the determination, content associated with the social networking group; and
providing the selected content for display to the user.

2. The method of claim 1, wherein the determining is further based on whether the user was active in the social networking group for the current time period, whether the user was active in the social networking group for a prior time period, and a number of times the user was active in the social networking group during one or more prior time periods.

3. The method of claim 1, wherein the determining is further based on an amount of time the user was active in the social networking group for the current time period.

4. The method of claim 1, wherein the determining is further based on a number of meaningful connections the user established during one or more prior time periods.

5. The method of claim 1, wherein the determining is further based on a time elapsed since the user joined the social network.

6. The method of claim 1, wherein the determining is further based on a number of meaningful connections associated with the social networking group for the current time period.

7. The method of claim 1, wherein the selecting further comprises selecting content associated with the social networking group when the determination indicates that the user will not establish the meaningful connection for the next time period.

8. The method of claim 1, further comprising selecting content from the social network to provide to the user.

9. A computer-readable medium comprising computer-readable instructions that, when executed by at least one processor of a computing device, cause the computing device to:
measure a user's activity for at least a current time period with respect to a social networking group of a social network;
determine, based on at least the user's activity, whether the user will establish a meaningful connection with the social networking group for a next time period, wherein the meaningful connection indicates the user satisfies a threshold amount of activity with the social networking group for a time period;
select, based on the determination, content associated with the social networking group; and
provide the selected content for display to the user.

10. The computer-readable medium of claim 9, wherein the determining is further based on an amount of time the user was active in the social networking group for the current time period.

11. The computer-readable medium of claim 9, wherein the determining is further based on a number of meaningful connections the user established during one or more prior time periods.

12. The computer-readable medium of claim 9, wherein the determining is further based on a time elapsed since the user joined the social network.

13. The computer-readable medium of claim 9, wherein the determining is further based on a number of meaningful connections associated with the social networking group for the current time period.

14. The computer-readable medium of claim 9, wherein the selecting further comprises selecting content associated with the social networking group when the determination indicates that the user will not establish the meaningful connection for the next time period.

15. A system comprising:
one or more processors;
a memory comprising instructions that when executed by the one or more processors cause the system to:
measure a user's activity for at least a current time period with respect to a social networking group of a social network;
determine, based on at least the user's activity, whether the user will establish a meaningful connection with the social networking group for a next time period, wherein the meaningful connection indicates the user satisfies a threshold amount of activity with the social networking group for a time period;
select, based on the determination, content associated with the social networking group; and
provide the selected content for display to the user.

16. The system of claim 15, wherein the determining is further based on an amount of time the user was active in the social networking group for the current time period.

17. The system of claim 15, wherein the determining is further based on a number of meaningful connections the user established during one or more prior time periods.

18. The system of claim 15, wherein the determining is further based on a time elapsed since the user joined the social network.

19. The system of claim 15, wherein the determining is further based on a number of meaningful connections associated with the social networking group for the current time period.

20. The system of claim 15, wherein the selecting further comprises selecting content associated with the social networking group when the determination indicates that the user will not establish the meaningful connection for the next time period.
